(19) United States
(12) Patent Application Publication
(10) Pub. No.: US 2012/0164369 A1
(43) Pub. Date: Jun. 28, 2012

(54) DISPOSABLE CAR MATS

(76) Inventor: CLAUDIA TARDIF, STE-FOY (CA)

(21) Appl. No.: 13/410,728

(22) Filed: Mar. 2, 2012

(30) Foreign Application Priority Data
Mar. 8, 2001 (CA) 2733464

(51) Int. Cl. B32B 3/10; B32B 3/06

(52) U.S. Cl. 428/99; 428/138

(57) ABSTRACT

A disposable car mat, comprising an absorbent layer; and a top surface secured on top of the absorbent layer; wherein the top surface comprises apertures; and the top surface directs incoming liquids to the absorbent layer through the apertures.

### CROSS REFERENCE TO RELATED APPLICATIONS

This application claims benefit of Canadian application Ser. No. 2,733,464 filed on Mar. 8, 2011. All documents above are incorporated herein in their entirety by reference.

### FIELD OF THE INVENTION

The present invention relates to car mats. More precisely, the present invention relates to disposable car mats.

### BACKGROUND OF THE INVENTION

Car mats are used to protect the floor in cars and other vehicles from getting dirty with slush, mud, dirt and water. Car mats come in a variety of materials, usually of weather resistant, thick durable materials that can sustain a rough usage, such as heavy-duty rubber.

There is still a need in the art for disposable car mats.

### SUMMARY OF THE INVENTION

More specifically, in accordance with the present invention, there is provided a disposable car mat, comprising an absorbent layer; and a top surface secured on top of the absorbent layer; wherein the top surface comprises apertures; and the top surface directs incoming liquids to the absorbent layer through the apertures.

Other objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

In the appended drawings:

FIG. 1 is an exploded view of a car mat according to an embodiment of an aspect of the present invention;

FIG. 2 is a top perspective view of the car mat of FIG. 1;

FIG. 3 is a top perspective view of the top surface of the car mat of FIG. 1;

FIG. 4 is a top perspective view of the bottom surface of the car mat of FIG. 1;

FIG. 5 is a top perspective view of the layer in the car mat of FIG. 1;

FIGS. 6a-6d illustrate formation of plies in the top sheet of a car mat according to an embodiment of an aspect of the present invention; and

FIGS. 7a-7b show side views of a car mat according to the embodiment of FIG. 6.

### DESCRIPTION OF EMBODIMENTS OF THE INVENTION

The disposable car mat will be described hereinbelow in relation to illustrative embodiments.

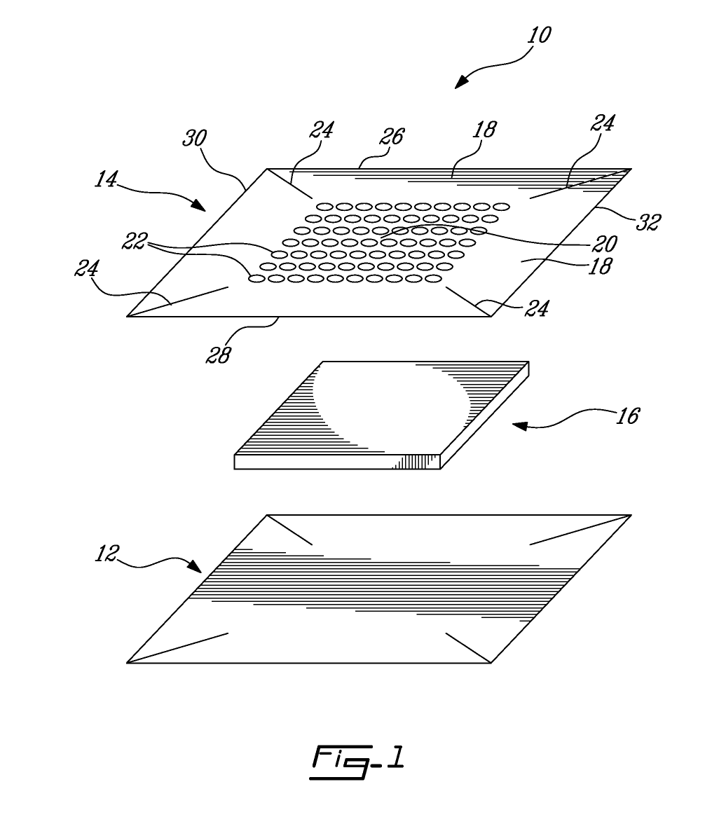

As shown in an embodiment illustrated in FIG. 1, the disposable mat 10 comprises an absorbent layer 16 secured underneath a top sheet 14. The mat 10 may further comprise a bottom sheet 12 in contact with the floor, the absorbent layer 16 thus secured between the top sheet 14 and the bottom sheet 12.

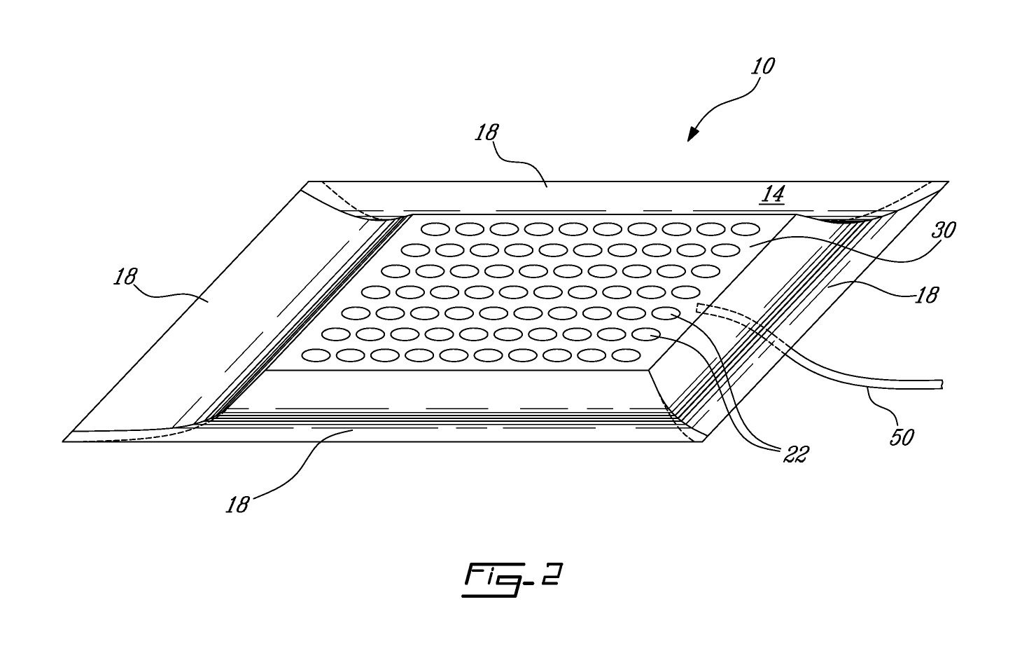

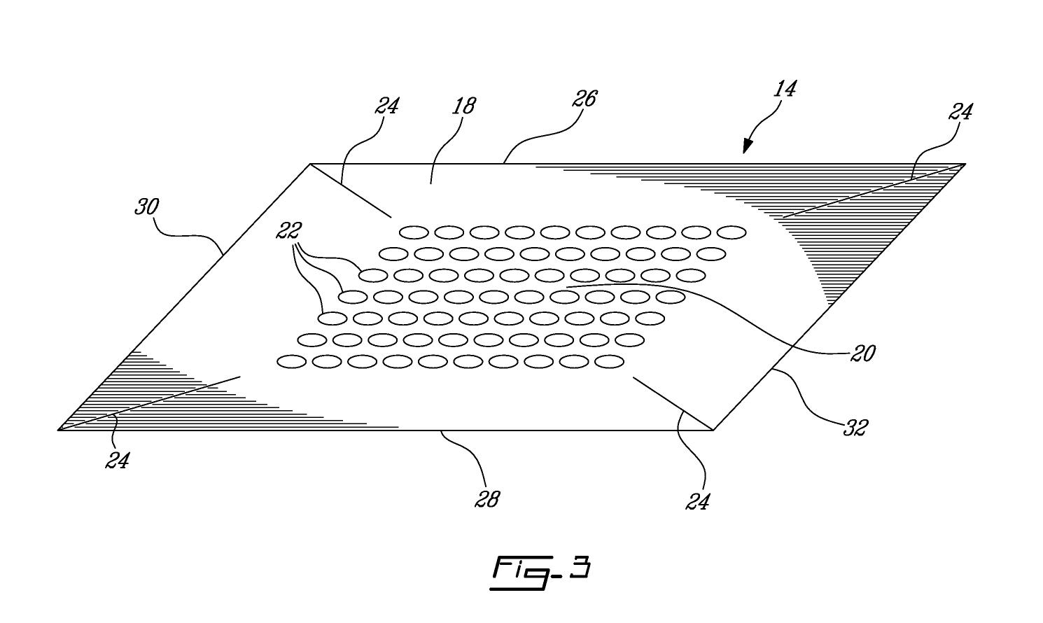

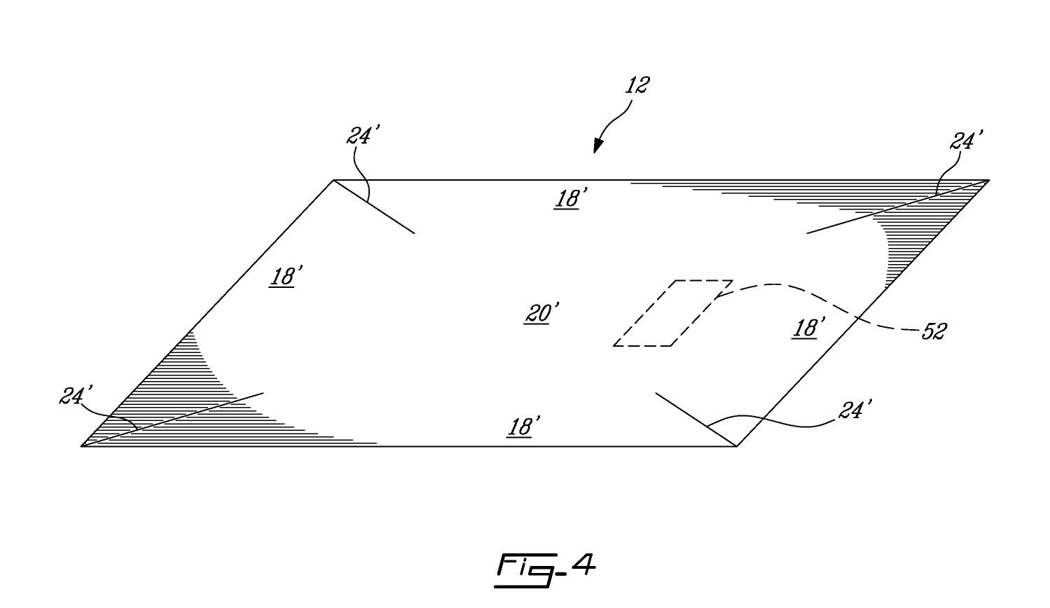

The top and bottom sheets 12, 14 are shaped (see FIGS. 3 and 4 for example), so that the resulting mat 10, as illustrated for example in FIG. 2, fits on the floor space available in front of a seat in a vehicle for example. Although the top and bottom sheets 12, 14 are shown as two separate pieces of material in the examples illustrated herein, they may be formed out of a single piece of material folded once into itself for example.

Both sheets 12 and 14 are made in non-inflammable, impervious, tear-resistant, antiskid, flexible materials, such as sheets of polypropylene or composites sheets like Typar™.

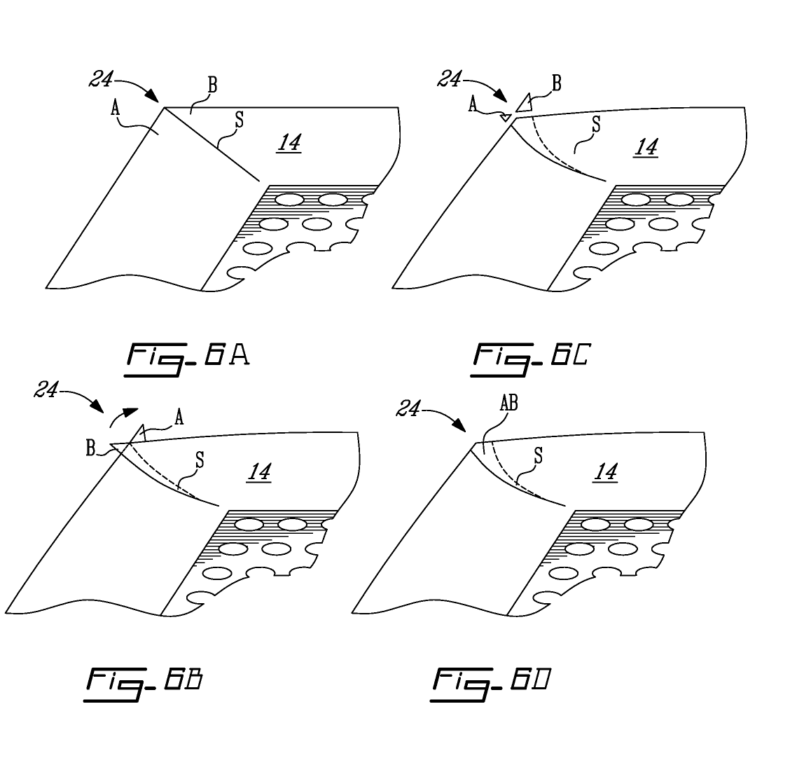

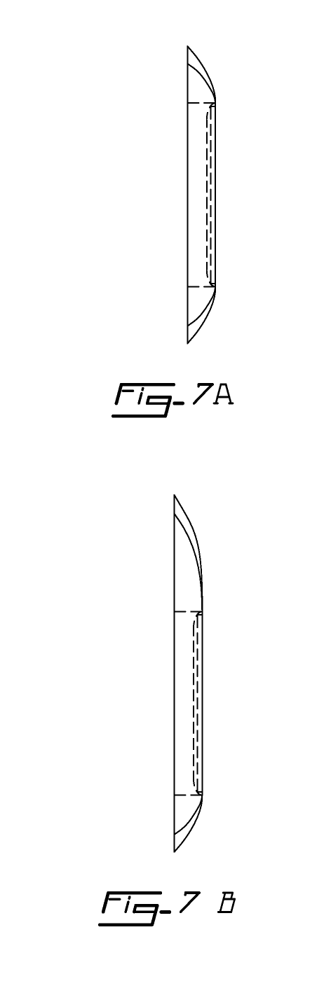

The top sheet 14 comprises a peripheral region 18 and a central region 20. The peripheral region 18 is delimitated by plies 24, shown in the corners of the sheet 14 in FIG. 3, so that the edges 26, 28, 30 and 32 of the sheet 14 curve up from the central region 20, thereby creating a slope down from the edges towards the central region 20, which directs incoming liquids toward the central region 20 (see FIGS. 6, 7). The central region 20 is provided with apertures 22.

The layer 16 is shaped so as to generally fit within the central region 20 of the top sheet 14. It is shown with a rectangle shape, but could have different geometries. It is made in a non-inflammable highly absorbent material, such as composites of cellulose fibers and polymer for example or such as used for diapers for example. The thickness of the layer 16 may be selected depending on the absorption capacity of the material of the layer 16 and of a desired absorption capacity for the mat 10. A typical thickness is comprised in a range between 1/4 and ½ inch.

The bottom sheet 12, shown for example in FIG. 4, receives the layer 16, generally centered on the surface of the bottom sheet 12, the top sheet 14 being secured on top of the bottom sheet 12, for example by sewing. The bottom sheet 12 may also comprise a peripheral region 18′ with plies 24′ in the corners, around a central region 20′, as shown in FIG. 4.

As shown in FIG. 2, the resulting mat 10, seen from above, provides a central region 20 directing liquids occurring on the mat's top surface to the absorbent layer 16 through the apertures 22. The curved peripheral region 18 (see FIG. 7) allows draining liquids from the edges of the mat towards the apertures 22 in the central region 20 of the top sheet 14 for absorption by the layer 16, so that the top surface of the mat 10 remains free of liquids and humidity.

As shown in FIGS. 6 and 7, each corner 24 of the top surface of the mat 10 may be provided with a slot (S), thereby creating two flaps A and B. Flap B can thus be folded over flap A (FIGS. 6B, 6C) and secured on top of flap A (FIG. 6D), by stitching for example, which causes the corners 24 to curve up from the central region 20 outwards (FIG. 7).

When the absorption capacity of the layer 16 is reached, the edges 26, 28 and 30, 32 of the mat 10 may simply be folded towards the center region 20 of the mat, and the mat, thus foldingly secured using a fastener such as Velcro™ for example, may then removed from the car, without any liquid spilling therefrom, for disposal thereof.

The mat life time depends on the amount of liquids received by the top surface of the mat 10 and of the absorption capacity of the layer 16. It may last, in case of a daily use and average precipitation, for more than 3 weeks, depending on the absorption capacity of the layer 16. When the layer 16 has reached its full capacity, the mat may be removed and replaced as described hereinabove.

The present disposable mats, which can absorb and encapsulate liquids at a significant rate, may be particularly useful in case of heavy usage and of the possibilities of spills, for example in periods of snow when footwears can bring in a lot of slush, etc.

The present disposable cars mat may be used alone, so as to protect the floor of a vehicle, or underneath regular car mats to protect the regular car mats and/or prevent overspills.

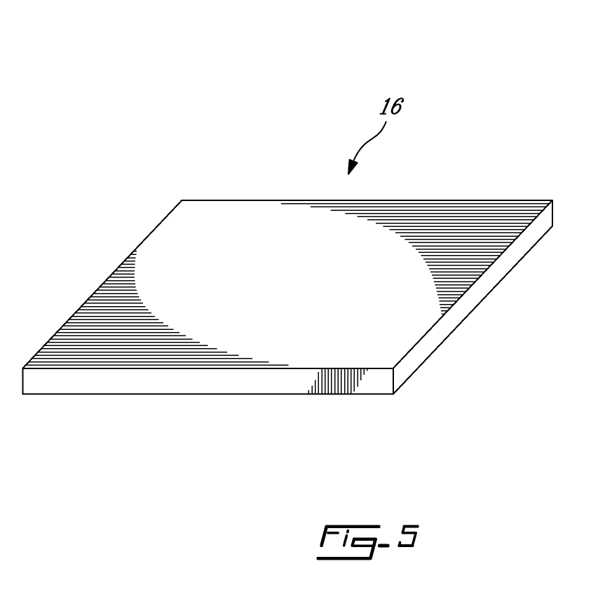

The present disposable car mat may be secured in place in front of a seat in a vehicle by a rope 50 (see FIG. 2), which can be fastened to the foot of the seat for example, in such a manner that the mat stays securely adhered to the desired surface. This may be important if the vehicle is exposed to spills, etc. It is found that a rope 50, offset relative to the middle of the width of the car mat as illustrated in FIG. 2, is most effective in preventing the car mat from moving around on the floor. Other means for securing the car mat to the floor could be used, such as Velcro™ 52 on the underneath surface of the bottom sheet for example (see FIG. 5).

The present disposable car mat acts as an excellent form of protection for the car's carpeting during bad weather, but also for example during oil changes, etc. It does not crack, break or shrink under use, and does not damage the carpet flooring, since it does not move around.

Advantageously, the present disposable car mat does not smell of rubber, in contrast to heavy duty car mats known in the art for example. It keeps a car fresh and tidy, and without humidity excess. It is handy, easily installed and removed, and protects both the floor and the shoes and feet of the user of the vehicle, since it ensures a stepping surface free of water and excess humidity.

Although the present invention has been described hereinabove by way of embodiments thereof, it may be modified, without departing from the nature and teachings of the subject invention as recited hereinbelow.

What is claimed is:

1. A disposable car mat, comprising:
an absorbent layer; and
a top surface secured on top of said absorbent layer;
wherein said top surface comprises apertures; and said top surface directs incoming liquids to said absorbent layer through said apertures.

2. The disposable car mat of claim 1, wherein said top surface comprises a central region and a peripheral region, said apertures being provided in said central region of said top surface, said peripheral region of said top surface curving up from said central region and draining liquids from edges of the mat towards said apertures in the central region of the top surface for absorption by said absorbent layer.

3. The disposable car mat of claim 1, edges of said mat being adapted to be folded back toward a center of said mat for removal of the mat once the absorption capacity of said absorbent layer is reached.

4. The disposable car mat of claim 1, further comprising a bottom surface, said absorbent layer being secured between said top surface and said bottom surface.

5. The disposable car mat of claim 1, further comprising a bottom surface, said absorbent layer being secured between said top surface and said bottom surface, said top surface comprising a central region provided with said apertures, and a peripheral region, edges of said top surface on said peripheral region of said top surface curving up from said central region of said top surface.

6. The disposable car mat of claim 1, wherein said top surface comprises a central region and a peripheral region, said central region being provided with said apertures, and said absorbent layer is shaped so as to generally fit within the central region of the top surface.

7. The disposable car mat of claim 1, further comprising a bottom surface, said absorbent layer being secured between said top surface and said bottom surface, said bottom surface and said top surface having a generally identical shape.

8. The disposable car mat of claim 1, wherein said top surface is a sheet of a non-inflammable, impervious, tear-resistant, antiskid, flexible material.

9. The disposable car mat of claim 1, wherein said top surface is a sheet of polypropylene.

10. The disposable car mat of claim 1, wherein said top surface is a sheet of a composite material.

11. The disposable car mat of claim 1, wherein said absorbent layer is a film of a non-inflammable highly absorbent material.

12. The disposable car mat of claim 1, wherein said absorbent layer is a film of a composite of cellulose fibers and polymer.

13. The disposable car mat of claim 1, wherein said absorbent layer has a thickness comprised in a range between about ¼ and about ½ inch.

14. The disposable car mat of claim 1, further comprising a rope adapted to be fastened to a fixed element in a vehicle, thereby maintaining the mat into a desired location on the floor of the vehicle.

15. The disposable car mat of claim 1, further comprising a bottom surface, said absorbent layer being secured between said top surface and said bottom surface, said top surface and said bottom surfaces being in non-inflammable, impervious, tear-resistant, antiskid, flexible materials.

16. The disposable car mat of claim 1, further comprising a bottom surface, said absorbent layer being secured between said top surface and said bottom surface, said top surface and said bottom surfaces comprising polypropylene.

17. The disposable car mat of claim 1, further comprising a bottom surface, said absorbent layer being secured between said top surface and said bottom surface, said top surface and said bottom surfaces being made in a composite material.
